(19) United States
(12) Patent Application Publication
(10) Pub. No.: US 2012/0145635 A1
(43) Pub. Date: Jun. 14, 2012

(54) TREATMENT OF WATERS WITH MULTIPLE CONTAMINANTS

(76) Inventors: Arthur L. Lucas, III, Proctorville, OH (US); John E. Sawyer, Charleston, WV (US)

(21) Appl. No.: 13/274,283

(22) Filed: Oct. 14, 2011

Related U.S. Application Data
(60) Provisional application No. 61/393,020, filed on Oct. 14, 2010.

(51) Int. Cl. C02F 1/44; C02F 1/24; B01D 29/00

(52) U.S. Cl. 210/652; 210/335; 210/150; 210/703

(57) ABSTRACT

The present invention provides for a process for treating water with multiple contaminants. The process includes filtering the water to remove relatively large particulates and immiscible organic fluids. The pH of the water is adjusted. Components such as sulfates are added to precipitate heavy metals. Any suspended solids and residual organic compounds are removed with an enhanced air flotation device. The resulting water is then passed through a reverse osmosis system whereby the water is treated in a cascading stage-wise manner with one or more selective membrane units.

### REFERENCE TO PENDING APPLICATIONS

This application claims the benefit of U.S. Provisional Patent Application Ser. No. 61/393,020 filed on Oct. 14, 2010 entitled Treatment of Waters with Multiple Contaminants.

### REFERENCE TO MICROFICHE APPENDIX

This application is not referenced in any microfiche appendix.

### BACKGROUND OF THE INVENTION

1. Field of the Invention

The present invention is generally directed toward removing contaminants found in water, and more specifically, toward removing contaminants found in water produced from oil and gas drilling.

2. Background

The hydraulic fracturing technique has been used for many years in the United States to enhance oil and gas recovery in the petrochemical industry. More recently, the use of hydraulic fracturing in gas drilling in the United States has increased significantly and in particular in the Marcellus Shale in the Eastern United States.

Current drilling technique involves drilling vertically to the level of the shale and then horizontally into the shale layer; the horizontal drilling allows more contact area for the fracturing and consequently a better gas yield.

For gas drilling, hydraulic fracturing, which is often referred to as “fracing”, involves the use of high pressure water to fracture the shale layer and release the natural gas. The frac fluid is mostly water but does contain a proppant (approx. 9.5%) and chemical additives (approx. 0.5%) that are present to enhance the process. The proppant is either fine sand or ceramic particles and is used to prop open the minute fractures in the shale and allow gas to flow.

Later in the fracing process, a certain amount of the frac fluid returns to the surface (flow-back). The amount of flow-back can be significant, depending on the size of the site and the number of wells and it is not untypical to have several hundred thousand gallons or more; unless the fluid is recycled or removed from the site, it must be stored in lined pits or tanks to await treatment or removal. After the flow-back fluid, the stream changes to “produced water” which is natural water from the shale layer The flow-back fluid and produced water—sometimes referred to collectively as “frac water”—contain the original frac fluid components and dissolved minerals from the shale and rock formations. Typically, the largest component is brine (sodium chloride) then lesser amounts of calcium ion, organic compounds, particulate and heavy metals (e.g. barium ion and strontium ion). The composition of frac water can vary significantly depending on the location and the geology of the area.

In general, there are several contaminants in surface waters that are of considerable concern due to their effects on wildlife as well as humans. The contaminants that are soluble are measured collectively as Total Dissolved Solids (TDS) and are typically metal salts of acids. A high TDS value has been shown to be detrimental to aquatic life. At the same time, a level of TDS that is too low is also detrimental to aquatic life.

Also of concern are organic compounds that are residues of oil or gas production. These may be toxic, or simply block removal of the TDS by fouling of the removal method such as the reverse osmosis membranes in a reverse osmosis process.

Other classes of contaminant are heavy metals, which must be separated from the salt residue to allow reuse of the salts, and suspended solids, which must be removed to prevent fouling of the reverse osmosis membrane.

Thus, there is a need for a process to remove contaminants found in water produced from oil and gas drilling.

### BRIEF SUMMARY OF THE INVENTION

The present invention is generally directed toward removing contaminants found in water, and more specifically, toward removing contaminants found in water produced from oil and gas drilling.

It is to be understood that the invention is not limited in its application to the details of the construction and arrangement of parts illustrated in the accompanying drawings. The invention is capable of other embodiments and of being practiced or carried out in a variety of ways. It is to be understood that the phraseology and terminology employed herein are for the purpose of description and not of limitation.

One aspect of the present invention discloses a process for treating water with multiple contaminants. This process includes the filtering of the water to, remove relatively large particulates. The resulting water is then filtered with an oil-coalescing filter to remove immiscible organic fluids. The pH of the water is adjusted along with the addition of components such as sulfates to precipitate heavy metals and the removing the heavy metal salts by filtration. Suspended solids and residual organic compounds are then removed with an enhanced air flotation device. The resulting water solution is passed through a reverse osmosis system whereby the water is treated in a cascading stage-wise manner with one or more selective membrane units.

One aspect of the reverse osmosis system of present invention includes passing the resulting water through a series of selective membrane unit until resulting solution is sufficiently diluted that a standard reverse osmosis unit will produce pure water as the permeate.

One aspect of the enhanced dissolved air flotation unit of the present invention includes micro bubbles to improve the dissolution of air in water containing suspended solids and organic micelles comprising.

Upon reading the above description, various alternative embodiments will become obvious to those skilled in the art. These embodiments are to be considered within the scope and spirit of the subject invention, which is only to be limited by the claims which follow and their equivalents.

### BRIEF DESCRIPTION OF THE DRAWINGS

FIG. 1 is a schematic diagram of an embodiment of the present invention.

FIG. 2 is a schematic diagram of an embodiment of the reverse osmosis aspect of the present invention.

### DESCRIPTION OF THE INVENTION

The present invention is generally directed toward removing contaminants found in water, and more specifically, toward removing contaminants found in water produced from oil and gas drilling.

In general, there are several contaminants in surface waters that are of considerable concern due to their effects on wildlife as well as humans. The contaminants that are soluble are measured collectively as Total Dissolved Solids (TDS) and are typically metal salts of acids. A high TDS value has been shown to be detrimental to aquatic life. At the same time, a level of TDS that is too low is also detrimental to aquatic life. Thus, an aspect of this invention discloses the ability to assure the effluent waters have an acceptable level of TDS, neither too high nor too low.

An embodiment of the present invention is disclosed as follows. Untreated produced water (also known as frac water) is decanted and coalesced to separate the light fracing fluid and/or organic compounds from the water. Additionally, other types of process conditioning such as the addition or removal of heat and pressure may be applicable and common in practice to separate organic compounds and water emulsions.

The produced water then subjected to processes to remove heavy metals. Heavy metals are precipitated out, such that the final salts will not be contaminated with toxic heavy metals, and can be reused for other commercial purposes. These treatments are well known, and include adding sulfate to precipitate barium, adjusting the pH to the slightly basic and allowing iron, manganese, aluminum, and similar metals to hydrate and precipitate. To speed the hydration and flocculation, additional compounds may be added to the water. If necessary, treatments for selenium and mercury may be added.

The water is then treated with a dissolved air flotation step to remove the suspended solids, and a portion of the residual (miscible and immiscible) organic compounds. As standard dissolved air flotation (DAF) systems are not as effective as desired, an enhanced version is part of this invention.

Any remaining micelles of immiscible organic compounds found in the water are removed by a coalescing filter. The removal of these compounds helps protect the system from premature fouling and operation inefficiency.

Finally, the water is passed through a reverse osmosis (RO) unit to remove any dissolved solids, primarily metal salts of acids. In most cases, these will be primarily metal chlorides with some sulfates. This RO unit will consist of a processing train of both conventional RO membranes along with Selective Membrane Units (SMU's). This water may be discharged, or reused in the drilling process. If discharged, it may be blended with a suitable amount of RO feed water to provide the necessary electrolytes for aquatic life, and the pH adjusted if necessary.

An embodiment of the enhanced dissolved air flotation (DAF) includes a method of removing suspended particles from a liquid by dissolving air at high pressure, releasing the pressure, and allowing the air bubbles to nucleate around the suspended particles, floating them to the surface. Once on the surface, they can be effectively removed by skimming. In a more advanced embodiments, the air bubbles are introduced in a much smaller form (or are broken into much smaller bubbles after introduction) preferably at low pressure, and then the pressure is raised to a high pressure, reducing the size of the bubbles further, and dissolving more of the air into the fluid. The air may also be introduced at high pressure as fine bubbles. In either case, the air bubbles may also be broken into smaller bubbles after the pressure is raised in the fluid. The smaller radius of the bubbles causes the internal pressure to be higher than the bulk fluid pressure due to the surface tension of the liquid. This effect is more pronounced for a fluid such as water with a relatively high surface tension. The dissolution of the air is further enhanced by holding the fluid under pressure for a period of time to allow the dissolution to proceed. After the air is dissolved, the pressure is released, and the dissolved air nucleates on any suspended solids, floating them to the surface. By enhancing the amount of air dissolved, the flotation is thereby enhanced as well, making separation more thorough, efficient and quicker.

Additionally, air dissolved in the fluid may also oxidize organic compounds dissolved in the fluid, thereby removing them from the fluid. Thus, ppm levels of such contaminants as benzene, toluene, xylene, and other noxious organic molecules may be removed or otherwise neutralized.

The fluid stream with bubbles is passed through a device to break the bubbles into smaller bubbles. Multiple passes through such device may be necessary to achieve the desired bubble size, and thus the desired dissolution of air in the fluid. Such devices include passing the fluid through small diameter nozzles at high flow rates, shear devices to mix the bulk fluid and stretch and break the bubbles into smaller bubbles, and similar devices. One embodiment of such device includes having orifice sizes in the range of 2 to 5 millimeters and preferentially in the range of 2 to 3 millimeters, impinging on a surface after traveling through the fluid for a distance of around 2 to 10 millimeters and preferentially around 5 millimeters. The fluid is passed through a multiplicity of these devices at velocities in the range of 3 to 7 meters per second. Passing the bubbles through small orifices at relatively high speeds reduces the bubble size significantly, further enhancing both the rate of dissolution due to higher bubble surface area and the aforementioned surface tension/pressure effects.

This enhanced dissolved air flotation (EDAF) unit is capable of removing or oxidizing ppm levels of organic materials left in the water, and removing essentially all of the suspended solids and micelles which are too small to coalesce.

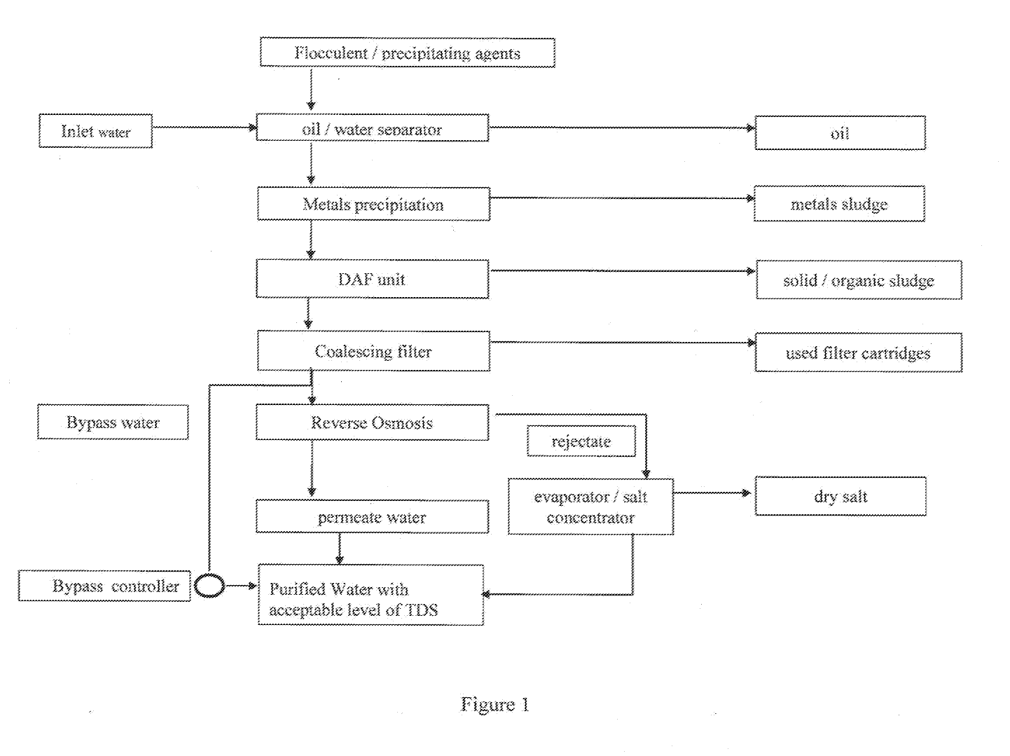

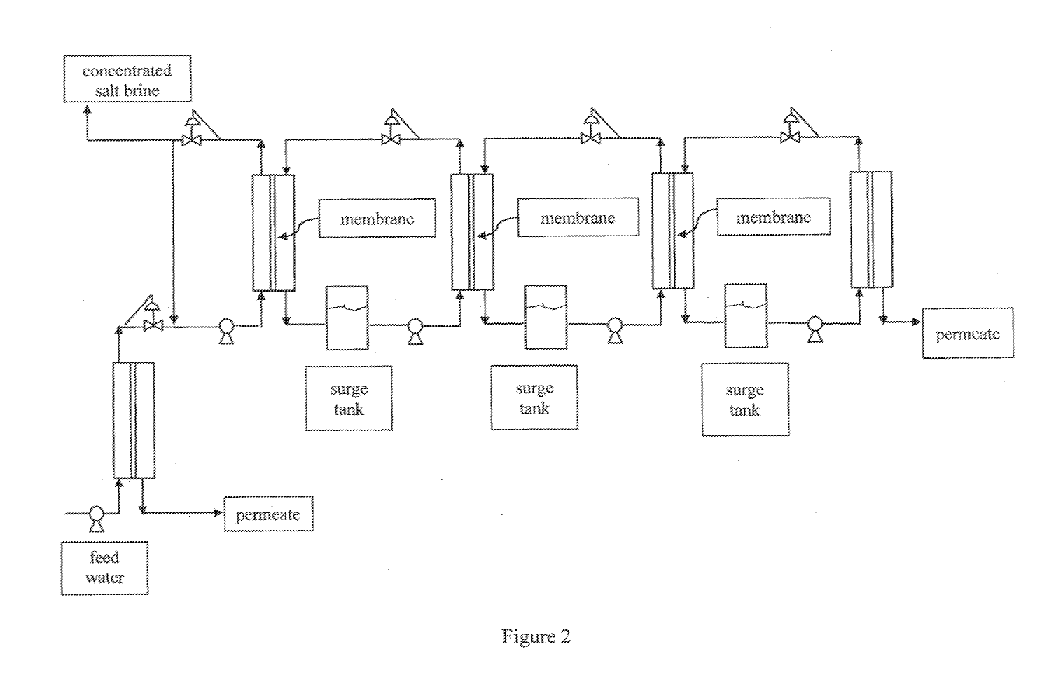

An embodiment of the reverse osmosis process is depicted in FIGS. 1 and 2. This embodiment uses multiple membrane units to achieve more concentrated brine solutions at acceptable and much lower pressures across each membrane. The initial feed water is passed through a normal reverse osmosis unit, and the permeate sent to the clean water discharge. The reject water from the first step is passed through a series of SMU's in which the concentration is gradually decreased from close to the solubility limit to a concentration where a single RO step will produce clean water. The SMU design offers the ability to operate each of the cascading membranes at a much lower pressure as currently practiced in the traditional RO systems. By operating the unit at much lower pressures along with the internal recycling of retentate, this design is capable of producing a salt stream at concentrations at near saturation conditions. The permeate from the final RO step is sent to the clean water discharge.

Each of the internal recycle loops in the staged membrane system has a salt dissolved in the water that is recirculated. This salt may be the same as the salt in the feed solution, or different, and may also be a liquid to which the membranes are essentially impermeable. The concentration gradient across each membrane is held at a level enabling low pressure reverse osmosis. Since the SMU's only allow essentially pure water to cross the membrane, the concentrations stay relatively constant while the water is transferred through the system from high salt concentration to low. Additionally, a surge tank is situated in between each SMU and offers the flexibility to sustain consistent internal recycle during process startup and shutdown, process upsets or feed concentration variations. The difference in salt concentrations from one SMU to the next is initially set to calculated values based on the difference in pressure between the two membrane sides and the osmotic pressure differential between the two solutions. As the unit is operated, these concentrations will respond to changes in the inlet feed solution concentration and reach equilibrium values set by the difference in pressure between the feed and permeate in each membrane. Thus, the operational pressure of each SMU is constant and can be set accordingly to correspond to a desired outlet salt concentration, and will respond to changes to seek a new equilibrium value while still maintaining the overall efficiency and output value.

The outlet may be connected to a device to measure dissolved solids, and release the concentrated brine at a predetermined set point. This will typically be somewhat less than the solubility limit of the dissolved salts. This set point may be lowered to ease operation of the unit.

While all of the steps shown in FIG. 1 may be necessary, in some instances some of the steps will not be needed for treatment of specific waters.

Another embodiment of the present invention includes a process for treating water with multiple contaminants including filtering the water to remove relatively large particulates and filtering the water with an oil-coalescing filter to remove immiscible organic fluids. The pH of the water is adjusted and components such as sulfates are added to precipitate heavy metals. These heavy metal salts are removed salts by filtration. Suspended solids and residual organic compounds are removed with an enhanced air flotation device. The resulting water is then passed through a reverse osmosis system whereby the water is treated in a cascading stage-wise manner with one or more selective membrane units.

Another embodiment of the present invention includes a reverse osmosis system to treat water containing contaminants and produced from oil and gas drilling including passing the water through a plurality of selective membrane unit in which the concentration of contaminants is gradually decreased until clean water is produced.

Another embodiment of the reverse osmosis system of the present invention includes mixing the water with a first recycle stream of water creating a first water solution. Applying pressure to the water solution sufficient to passing the water solution through a first selective membrane unit creating a solution of salt from that portion of the water solution that did not pass through the first selective membrane and creating receiving solution from that portion of the water solution that did pass through the first selective membrane. The solution of salt is induced by the pressure to flow back into the first recycle stream.

The receiving solution is then mixed with a second recycle stream of water creating a second water solution. Applying pressure to the second water solution sufficient to passing the second water solution through a second selective membrane unit creating a second solution of salt from that portion of the water solution that did not pass through the second selective membrane and creating a second receiving solution from that portion of the second water solution that did pass through the second selective membrane. The solution of salt is then induced by the pressure to flow back into the second recycle stream.

The receiving solution is continued to be mixed with recycle stream of water and to have pressure applied to pass the resulting water solution through additional selective membrane units until the receiving solution is sufficiently diluted that a standard reverse osmosis unit will produce pure water as the permeate.

Another embodiment of the reverse osmosis system can include intermediate storage and circulation tanks located between each selective membrane unit to allow for changes in volume of the receiving solution. These tanks allow for the changes in volume of the resulting water as the amount of salt stays relatively constant and will also allow for the increase in volume as salt is transported with the water at different rates through the membranes due to the concentration differences, with provision to recycle excess solution from any one stage to a previous stage of the process, providing a counter-current flow of the salt that is transported through the membranes.

Another embodiment of the reverse osmosis system can include hearing the solution of salt under pressure and then removing the water away from the salt by flashed in a low pressure flash vessel producing a dry salt.

Another embodiment of the dissolved air flotation unit includes using micro bubbles to improve the dissolution of air in water containing suspended solids and organic micelles. This embodiment includes a pressure reducing valve to reduce the pressure of water to approximate atmospheric pressure, a vessel to release undissolved air within the water and to allow the dissolved air to nucleate on the solids and organic micelles separating them from the bulk fluid by the difference in density and a separation apparatus removing the suspended solids and organic micelles from the bulk fluid thereby purifying the water.

Another embodiment of a method for dissolution of air in water containing suspended solids and organic micelles includes increasing the pressure of the water up to between 4 to 10 bar, adding air to the water in a quantity close to the amount that will fully dissolve, passing the water through a first multiplicity of orifices having a size of between 3 to 7 M/S with a first change in direction after approximately 5 mm, passing thenwater through a second multiplicity of orifices having a size of between 3 to 7 M/S with a second change in direction after approximately 5 mm, continuing to pass the water through orifices coupled with changes of direction until the dissolution is complete; and holding the water at pressure for between 5 to 60 seconds to allow for dissolution to proceed and to separate out any undissolved air.

The major benefit from the present invention is the ability to remove multiple contaminants from contaminated waters in a more cost effective and energy efficient manner than other removal methods, producing pure water and either a highly concentrated salt solution, or a dry salt stream.

While the invention has been described with a certain degree of particularity, it is manifest that many changes may be made in the details of construction and the arrangement of components without departing from the spirit and scope of this disclosure. It is understood that the invention is not limited to the embodiments set forth herein for purposes of exemplification.

1. A reverse osmosis system to treat water containing contaminants and produced from oil and gas drilling comprising:
passing the water through a plurality of selective membrane unit in which the concentration of contaminants is gradually decreased until clean water is produced.

2. The reverse osmosis system of claim 1, wherein passing the water comprises;
mixing the water with a first recycle stream of water creating a first water solution;
applying pressure to the water solution sufficient to passing the water, solution through a first selective membrane unit creating a solution of salt from that portion of the water solution that did not pass through the first selective membrane and creating receiving solution from that portion of the water solution that did pass through the first selective membrane, the solution of salt being induced by the pressure to flow back into the first recycle stream;
mixing the receiving solution with a second recycle stream of water creating a second water solution;
applying pressure to the second water solution sufficient to passing the second water solution through a second selective membrane unit creating a second solution of salt from that portion of the water solution that did not pass through the second selective membrane and creating a second receiving solution from that portion of the second water solution that did pass through the second selective membrane, the solution of salt being induced by the pressure to flow back into the second recycle stream;
continuing to mix the receiving solution with a recycle stream of water and to apply pressure to pass the resulting water solution through additional selective membrane units until the receiving solution is sufficiently diluted that a standard reverse osmosis unit will produce pure water as the permeate.

3. The reverse osmosis system of claim 2 further comprising:
intermediate storage and circulation tanks located between each selective membrane unit to allow for changes in volume of the receiving solution.

4. The reverse osmosis system of claim 2 wherein the solution of salt is heated under pressure and then removing the water away from the salt by flashed in a low pressure flash vessel producing a dry salt.

5. An enhanced dissolved air flotation unit using micro bubbles to improve the dissolution of air in water containing suspended solids and organic micelles comprising:
a pressure reducing valve reducing the pressure of water to approximate atmospheric pressure;
a vessel to release undissolved air within the water and to allow the dissolved air to nucleate on the solids and organic micelles separating them from the bulk fluid by the difference in density; and
a separation apparatus removing the suspended solids and organic micelles from the bulk fluid thereby purifying the water.

6. A method for dissolution of air in water containing suspended solids and organic micelles comprising the steps of:
increasing the pressure of the water up to between 4 to 10 bar;
adding air to the water in a quantity close to the amount that will fully dissolve;
passing the water through a first multiplicity of orifices having a size of between 3 to 7 M/S with a first change in direction after approximately 5 mm;
passing the water through a second multiplicity of orifices having a size of between 3 to 7 M/S with a second change in direction after approximately 5 mm
continuing to pass the water through orifices coupled with changes of direction until the dissolution is complete; and
holding the water at pressure for between 5 to 60 seconds to allow for dissolution to proceed and to separate out any undissolved air.

7. A process for treating water with multiple contaminants consisting of:
filtering the water to remove relatively large particulates;
filtering the water with an oil-coalescing filter to remove immiscible organic fluids;
adjusting the pH and adding components such as sulfates to precipitate heavy metals and the removing the heavy metal salts by filtration;
removing suspended solids and residual organic compounds with an enhanced air flotation device;
passing the water through a reverse osmosis system whereby the water is treated in a cascading stage-wise manner with one or more selective membrane units.

8. The process of claim 7, wherein the enhanced air flotation device:
increases the pressure of the water to between 4 to 10 bar;
adds air to the water in a quantity close to the amount that will fully dissolve;
passes the water through a one or more multiplicity of orifices having a size of between 3 to 7 M/S changing direction approximately 5 mm between each one or more multiplicity of orifices; and
provides a filtration of about one micron or less absolute to protect the osmosis membranes.

9. The process of claim 7, wherein the enhanced air flotation device comprises:
a volume to hold the water at pressure for approximately one minute;
a pressure reducing device to reduce the pressure to about atmospheric pressure;
a vessel to release undissolved air within the water and to allow the dissolved air to nucleate on the solids and organic micelles separating them from the bulk fluid by the difference in density; and
a separation apparatus removing the suspended solids and organic micelles from the bulk fluid thereby purifying the water.

10. The process of claim 7, wherein the reverse osmosis system comprises:
passing the water through a plurality of selective membrane unit in which the concentration of contaminants is gradually decreased until clean water is produced.

11. The process of claim 7, wherein the reverse osmosis system comprises:
mixing the water with a first recycle stream of water creating a first water solution;
applying pressure to the water solution sufficient to passing the water solution through a first selective membrane unit creating a solution of salt from that portion of the water solution that did not pass through the first selective membrane and creating receiving solution from that portion of the water solution that did pass through the first selective membrane, the solution of salt being induced by the pressure to flow back into the first recycle stream;
mixing the receiving solution with a second recycle stream of water creating a second water solution;
applying pressure to the second water solution sufficient to passing the second water solution through a second selective membrane unit creating a second solution of salt from that portion of the water solution that did not pass through the second selective membrane and creating a second receiving, solution from that portion of the second water solution that did pass through the second selective membrane, the solution of salt being induced by the pressure to flow back into the second recycle stream;
continuing to mix the receiving solution with a recycle stream of water and to apply pressure to pass the resulting water solution through a selective membrane unit until the receiving solution is sufficiently diluted that a standard reverse osmosis unit will produce pure water as the permeate.
